(19) United States
(12) Patent Application Publication
(10) Pub. No.: US 2024/0272537 A1
(43) Pub. Date: Aug. 15, 2024

(54) ILLUMINATION SYSTEM AND PROJECTION DEVICE

(71) Applicant: Coretronic Corporation, Hsin-Chu (TW)

(72) Inventors: Chun-Hsin Lu, Hsin-Chu (TW); Jen-Wei Kuo, Hsin-Chu (TW); Wen-Chieh Chung, Hsin-Chu (TW)

(73) Assignee: Coretronic Corporation, Hsin-Chu (TW)

(21) Appl. No.: 18/433,299

(22) Filed: Feb. 5, 2024

(30) Foreign Application Priority Data
Feb. 14, 2023 (CN) 202310108115.1
May 30, 2023 (CN) 202310622623.1

(51) Int. Cl. G03B 21/20; G02B 3/00; G02B 27/09; G02B 27/14

(52) U.S. Cl. CPC G03B 21/208; G02B 3/0056; G02B 27/0933; G02B 27/141; G02B 2003/0093

(57) ABSTRACT

An illumination system configured to provide an illumination light is provided. The illumination system includes a light source, a light-homogenizing device, and a light-homogenizing element. The light source includes multiple light-emitting units, and the light-emitting units emit multiple light beams respectively. The light-homogenizing device includes a micro-lens-array element. The micro-lens-array element includes multiple micro lenses, and each of the light beams irradiates at least two of the micro lenses. The light beams are totally overlapped, non-overlapped, or partially overlapped with each other before being incident on the light-homogenizing device, and overlapped with each other on an incident surface of the light-homogenizing element. A projection device is also provided.

### CROSS-REFERENCE TO RELATED APPLICATION

This application claims the priority benefit of China application serial no. 202310108115.1, filed on Feb. 14, 2023, and China application serial no. 202310622623.1, filed on May 30, 2023. The entirety of each of the above-mentioned patent applications is hereby incorporated by reference herein and made a part of this specification.

### BACKGROUND

### Technical Field

The disclosure relates to an illumination system and a projection device.

### Description of Related Art

In recent years, in order to increase brightness of a light source module of a projection device and reduce use of a light-combining system, solid-state light sources such as laser diodes and light-emitting diodes have been designed to arrange multiple light sources of different colors in an array and package the light sources on a substrate to form a color light source module, or to arrange multiple light sources of the same color in an array and package the light sources on the substrate to form a monochromatic light source module.

However, both of the above two light source modules may cause an illumination beam to exceed an aperture (diaphragm) of a projection lens, resulting in waste of light energy, or be required to redesign the projection lens with a larger aperture, increasing the manufacturing difficulty and cost. In addition, the illumination beam generated by the above color light source module may further have uneven distribution of various colors of light, or the illumination beam generated by the above monochromatic light source module may further have uneven distribution of illuminance. Therefore, there is an urgent need for an illumination system that may overcome the above issues of exceeding the lens aperture and the uneven distribution of color and illuminance, so that a projection device using the illumination system may provide an optimized image beam at a lower manufacturing cost and difficulty.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system and a projection device.

Other objectives and advantages of the disclosure may be further understood from the technical features disclosed herein.

In order to achieve one, a part, or all of the above objectives or other objectives, according to an embodiment of the disclosure, an illumination system is provided to provide an illumination beam, including a light source, a light-homogenizing device, and a light-homogenizing element. The light source includes multiple light-emitting units. The light-emitting units respectively emit multiple light beams. The light-homogenizing device includes a micro-lens-array element. The micro-lens-array element includes multiple micro lenses. The light beams irradiate the micro-lens-array element, and each of the light beams irradiates at least two of the micro lenses. The light beams are non-overlapped or at least partially overlapped with each other before being incident on the light-homogenizing device, and the light beams are overlapped on a light incident surface of the light-homogenizing element.

According to an embodiment of the disclosure, a projection device is provided, including an illumination system, an optical engine module, and a projection lens. The illumination system is configured to provide an illumination beam, and includes a light source, a light-homogenizing device, and a light-homogenizing element. The light source includes multiple light-emitting units. The light-emitting units respectively emit multiple light beams. The light-homogenizing device includes a micro-lens-array element. The micro-lens-array element includes multiple micro lenses. The light beams irradiate the micro-lens-array element, and each of the light beams irradiates at least two of the micro lenses. The light beams are non-overlapped or at least partially overlapped with each other before being incident on the light-homogenizing device, and the light beams are overlapped on a light incident surface of the light-homogenizing element. The optical engine module is disposed on a transmission path of the illumination beam to convert the illumination beam into an image beam. The projection lens is disposed on a transmission path of the image beam to project the image beam out of the projection device.

In order for the aforementioned features and advantages of the disclosure to be more comprehensible, embodiments accompanied with drawings are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an illumination system according to the first embodiment of the disclosure.

FIG. 2A is a cross-sectional view of a micro-lens-array element according to the first embodiment of the disclosure.

FIG. 2B is a front view of the micro-lens-array element in FIG. 2A.

FIG. 2C is a schematic view of a hexagonal homogenization spot formed on a light incident surface of a light-homogenizing element according to the first embodiment of the disclosure.

FIG. 3A is a front view of a micro-lens-array element according to another embodiment of the disclosure.

FIG. 3B is a schematic view of a micro lens of the micro-lens-array element in FIG. 3A.

FIG. 3C is a schematic view of a micro lens of a micro-lens-array element according to another embodiment of the disclosure.

FIG. 3D is a schematic view of a micro lens of a micro-lens-array element according to still another embodiment of the disclosure.

(A) of FIG. 3E is a schematic view of a spot at an aperture of a projection lens according to a comparative example, and (B) of FIG. 3E is a schematic view of a spot at an aperture of a projection lens according to an embodiment of the disclosure.

FIG. 4A is a schematic view of an illumination system according to the second embodiment of the disclosure.

FIG. 4B is a front view of a micro-lens-array element according to the second embodiment of the disclosure.

FIG. 5 is a schematic view of an illumination system according to the third embodiment of the disclosure.

FIG. 6 is a schematic view of an illumination system according to the fourth embodiment of the disclosure.

FIG. 7 is a schematic view of a projection device according to an embodiment of the disclosure.

FIG. 8A is a schematic view of a light incident surface of a light-homogenizing element according to the fifth embodiment of the disclosure.

FIG. 8B is a front view of a micro-lens-array element according to the fifth embodiment of the disclosure.

FIG. 8C is a schematic view of a spot irradiated on a micro-lens-array element according to the fifth embodiment of the disclosure.

FIG. 8D is a schematic view of an image generating device according to the fifth embodiment of the disclosure, in which (A) of FIG. 8D is a front view of the image generating device, and (B) of FIG. 8D is a side view of the image generating device.

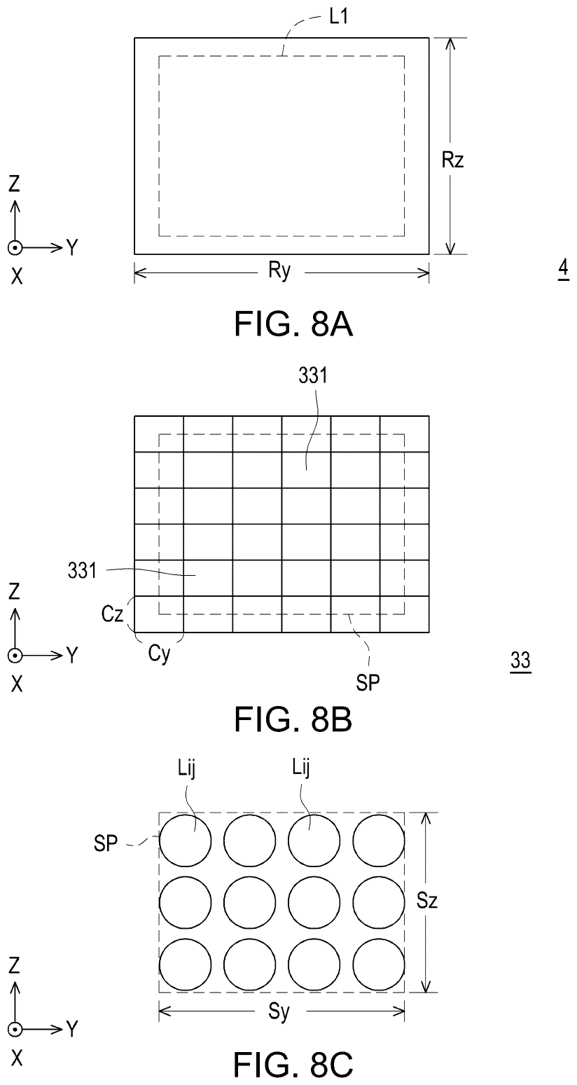

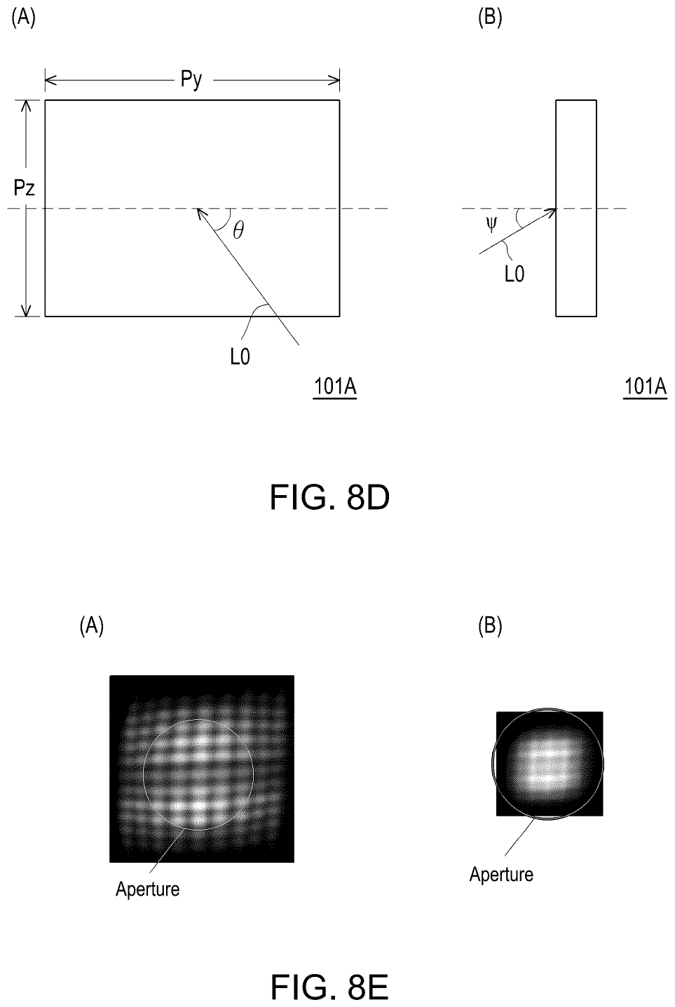

(A) of FIG. 8E is a schematic view of a spot at an aperture of a projection lens according to a comparative example, and (B) of FIG. 8E is a schematic view of a spot at an aperture of a projection lens according to the fifth embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

It is to be understood that both the foregoing and other detailed descriptions, features and advantages are intended to be described more comprehensively by providing an embodiment accompanied with figures hereinafter. Directional terms used in the following embodiments, such as upper, lower, left, right, front, and rear merely refer to directions in the accompanying drawings. Therefore, the directional terms are used to illustrate rather than limit the disclosure.

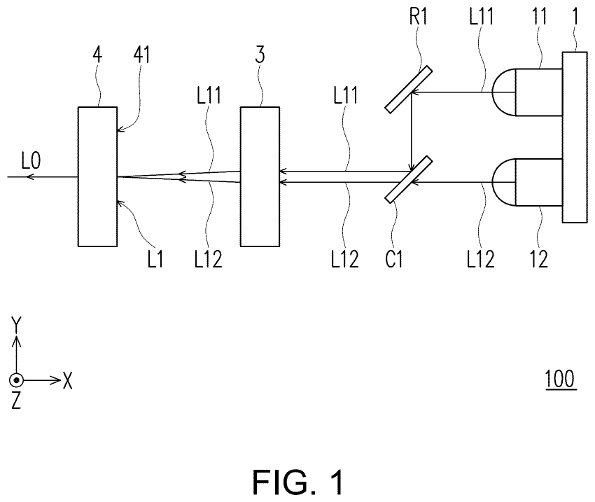

FIG. 1 is a schematic view of an illumination system according to the first embodiment of the disclosure. Referring to FIG. 1, an illumination system 100 is configured to provide an illumination beam L0 and includes a light source 1, a light-homogenizing device 3, and a light-homogenizing element 4. The light-homogenizing device 3 is disposed between the light source 1 and the light-homogenizing element 4. The light source 1 may include multiple light-emitting units (e.g., Light-emitting diodes or laser diodes). In this embodiment, two light-emitting units 11 and 12 are shown. However, the number of light-emitting units is not limited to 2 as shown in FIG. 1, which may be, for example, 4, 6, 8, or other numbers of light-emitting units. The light-emitting units 11 and 12 respectively emit light beams L11 and L12. In some embodiments, the light-homogenizing element 4 may include an integration rod or an lens-array, but the disclosure is not limited thereto. In this embodiment, the illumination system 100 may further optionally include a reflector R1 and a light-combining element C1 to guide the light beams L11 and L12.

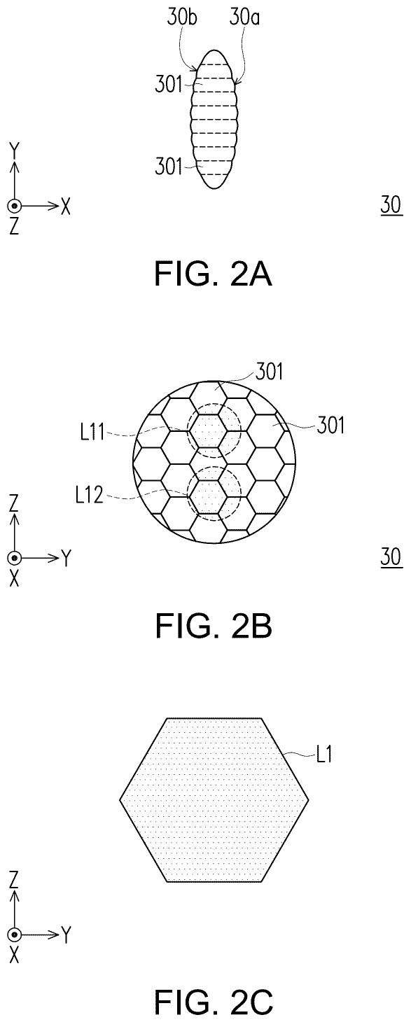

FIG. 2A is a cross-sectional view of a micro-lens-array element. FIG. 2B is a front view of the micro-lens-array element. FIG. 2C is a schematic view of a hexagonal homogenization spot formed on a light incident surface of a light-homogenizing element. Referring to FIGS. 1, 2A, 2B, and 2C, the light-homogenizing device 3 includes a micro-lens-array element 30, for example. The micro-lens-array element 30 has, for example, a positive diopter and includes multiple micro lenses 301. Each of the micro lenses 301 has a hexagonal outline in the front view (e.g., the micro lenses 301 are integrally formed). For example, the micro-lens-array element 30 has a light incident surface 30a and a light exit surface 30b. The light incident surface 30a faces the light source 1, and the light exit surface 30b faces the light-homogenizing element 4. In this embodiment, the light incident surface 30a and the light exit surface 30b are both curved surfaces, and the curved surfaces generates the diopter of the micro-lens-array element 30. However, the disclosure is not limited thereto. In some embodiments, only one of the light incident surface 30a and the light exit surface 30b is the curved surface. In particular, since the micro-lens-array element 30 is formed by the micro lenses 301, the curved surface of the micro-lens-array element 30 actually has ups and downs along with the micro lenses 301, as shown in FIG. 2A. In detail, in this embodiment, a thickness of the micro lens 301 located in a middle area of the micro-lens-array element 30 (a distance of the micro lens 301 on a direction parallel to an optical axis of the micro-lens-array element 30) is greater than a thickness of the micro lens 301 located in an edge area of the micro-lens-array element 30. It should be noted that, in this embodiment and other embodiments below, multiple light beams emitted by the light source 1 will be incident on the light-homogenizing device 3 in a parallel manner, and the light-homogenizing device 3 has an optical axis (not shown) parallel to a traveling direction of the light beams that are parallel to one another. The optical axis may pass through a geometric center of the light-homogenizing device 3.

It is particularly noted that in the disclosure, the outline of each of the micro lenses 301 is not limited to a hexagon, and in other embodiments, may have different designs corresponding to the light-homogenizing element 4, such as a triangle, a quadrangle, or other shapes that may form the densest stack. For example, when the light-homogenizing element 4 is an integration rod, and the light incident surface of the integration rod is a rectangle, the outline of each of the micro lenses 301 may be correspondingly designed as a rectangle (which will be described in further detail in other subsequent embodiments). When the light-homogenizing element 4 is an lens-array, the outline of each of the micro lens 301 may be correspondingly designed as a hexagon, octagon, decagon, or other polygonal shapes.

In the embodiment shown in FIG. 1, the light source 1 may be a colored light source. The light-emitting units 11 and 12 respectively emit the light beams L11 and L12 with different light frequency ranges, and the light-combining element C1 is, for example, a dichroic mirror. Specifically, the light-combining element C1 is disposed on transmission paths of the light beams L11 and L12. The reflector R1 is only disposed on the transmission path of the light beam L11. The light beam L11 is first reflected by the reflector R1, then reflected by the light-combining element C1, and transmitted to the light-homogenizing device 3. In addition, the light beam L12 passes through the light-combining element C1 and is transmitted to the light-homogenizing device 3.

The light beams L11 and L12 are parallel to each other and parallel to the optical axis (not shown) before being incident on the light-homogenizing device 3 (e.g., the light beams L11 and L12 are incident on the light-homogenizing device 3 at a same angle). The optical axis refers to an axis line that coincides with a geometric center axis of the light-homogenizing device 3 and/or coincides with a geometric center axis of the light-homogenizing element 4. Therefore, as shown in FIG. 2B, the spots of the light beams L11 and L12 irradiate on the micro-lens-array element 30 in different areas, and each of the spots irradiate at least two of the micro lenses 301. Therefore, the light beams L11 and L12 will be homogenized by the micro-lens-array element 30.

Furthermore, the light beams L11 and L12 pass through the light-homogenizing device 3 and then are transmitted to the light-homogenizing element 4. Since the micro-lens-array element 30 has the positive diopter, the light beams L11 and L12 may be converged on the light incident surface 41 of the light-homogenizing element 4 to generate a spot L1. Furthermore, since each of the micro lenses 301 has the hexagonal outline in the front view shown in FIG. 2B (that is, on a plane perpendicular to the optical axis), the spot formed by the light beam L11 on the light incident surface 41 of the light-homogenizing element 4 will be approximately hexagonal, and the spot formed by the light beam L12 on the light incident surface 41 of the light-homogenizing element 4 will also be approximately hexagonal. In addition, by designing the micro-lens-array element 30 to have appropriate refractive power, the respective spots of the light beams L11 and L12 may be overlapped on the light incident surface 41 of the light-homogenizing element 4 to form the approximately hexagonal homogenized spot L1 as shown in FIG. 2C.

In particular, in other embodiments of the disclosure, the light-emitting unit 11 includes multiple light-emitting units. The light beams L11 emitted by the light-emitting units are also reflected by the reflector R1 and then transmitted to the micro-lens-array element 30 (the light-homogenizing device 3). Since the light-emitting units are disposed separately in space, the transmission paths of the light beams may not be transmitted in a totally overlapping manner, but will be transmitted to the micro-lens-array element 30 in a non-overlapping or only partially overlapping manner. Similarly, when the light-emitting unit 12 includes multiple light-emitting units, the transmission paths of the light beams may not be transmitted in a totally overlapping manner, but will be transmitted to the micro-lens-array element 30 in a non-overlapping or only partially overlapping manner. However, even under the above conditions, no matter whether the light beams are non-overlapped or partially overlapped with each other before being incident on the micro-lens-array element 30 (the light-homogenizing device 3), the light beams may be homogenized by the corresponding micro lenses 301, and converged on the light incident surface 41 of the light-homogenizing element 4 after being refracted to generate the hexagonal homogenized spot L1 as shown in FIG. 2C.

In some embodiments, the light beams L11 and L12 are totally overlapped before being incident on the micro-lens-array element 30 (the light-homogenizing device 3), and may also be converged on the light incident surface 41 of the light-homogenizing element 4 through the micro-lens-array element 30 (the light-homogenizing device 3) to generate the hexagonal homogenized spot L1 as shown in FIG. 2C.

In the embodiments shown in FIGS. 1, 2A, 2B, and 2C, the light beams L11 and L12 are incident on the micro-lens-array element 30 (the light-homogenizing device 3) in parallel, but the disclosure is not limited thereto. In other embodiments, the light source 1 may include multiple light-emitting units. The light-emitting units emit multiple light beams, and the light beams are non-parallel incident on the micro-lens-array element 30 (the light-homogenizing device 3). By properly designing the diopter of the micro-lens-array element 30 (the light-homogenizing device 3), the light beams may be homogenized by the corresponding micro lenses 301, and converged on the light incident surface 41 of the light-homogenizing element 4 to generate the hexagonal homogenized spot L1 as shown in FIG. 2C.

In general, in the above embodiments, by disposing the micro-lens-array element 30 (the light-homogenizing device 3), the hexagonal homogenized spot L1 may be formed on the light incident surface 41 of the light-homogenizing element 4. Compared to the illumination system without the micro-lens-array element 30 (the light-homogenizing device 3) disposed therein, the illumination beam L0 provided by the illumination system 100 has optimized uniformity, a reduced speckle phenomenon, and a smaller beam width. In some optical applications, when a projection lens with a smaller aperture (diaphragm) is used, a smaller light beam and spot shape may be more suitable for the projection lens with the smaller aperture to improve the efficiency of light use, and may greatly reduce the manufacturing difficulty and cost. For example, in a case of using a small-aperture ultra-short-focus lens (such as an F3.0 lens), compared to the illumination system without the micro-lens-array element 30 (the light-homogenizing device 3) disposed therein, the efficiency of light use of the illumination beam L0 provided by the illumination system 100 is at least 10% higher, and the light uniformity is improved.

In order to fully illustrate various implementations of the disclosure, other embodiments of the disclosure will be described below. It is noted that some of the reference numerals and descriptions of the above embodiment will apply to the following embodiments. The same reference numerals will represent the same or similar components and the descriptions of the same technical contents will be omitted. Reference may be made to the above embodiment for the omitted descriptions, which will not be repeated in the following embodiments.

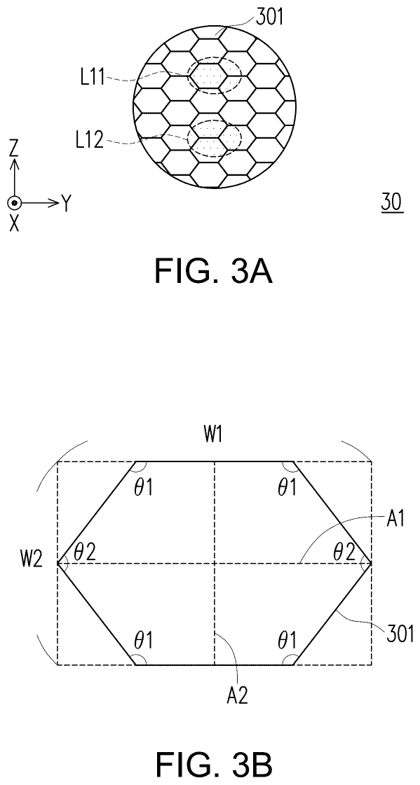

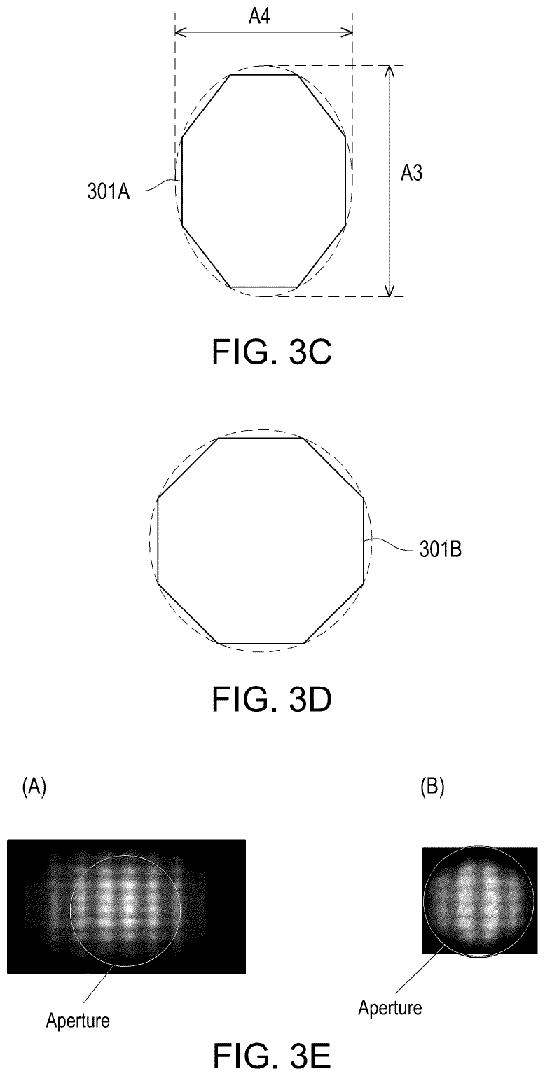

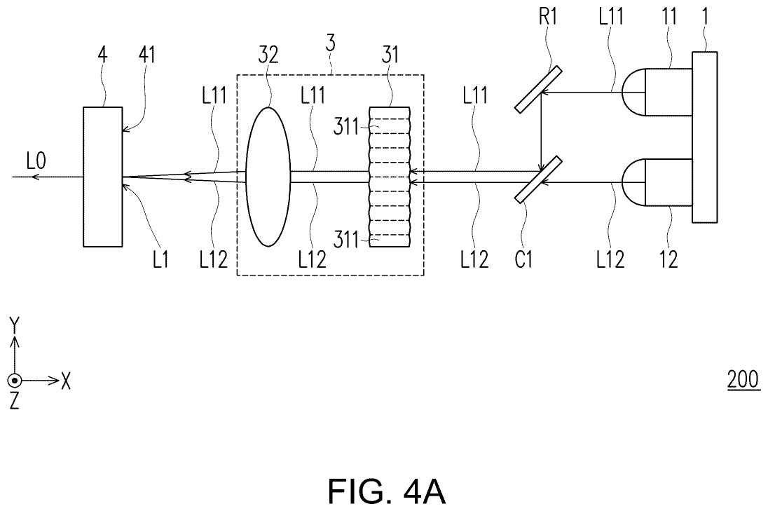

FIG. 3A is a front view of a micro-lens-array element according to another embodiment of the disclosure. FIG. 3B is a schematic view of a micro lens of the micro-lens-array element in FIG. 3A. Referring to FIGS. 3A and 3B, compared to the embodiment shown in FIG. 2B, the outline of each of the micro lenses 301 in this embodiment in the front view shown in FIG. 3A (that is, on the plane perpendicular to the optical axis) is not a regular hexagon, but a hexagon with symmetry axes A1 and A2 as shown in FIG. 3B. The hexagon of the outline of the micro lens 301 is symmetrical with respect to the symmetry axis A1 or the symmetry axis A2. The symmetry axis A1 is, for example, perpendicular to the symmetry axis A2, and a length of the symmetry axis A1 is greater than a length of the symmetry axis A2 (that is, the symmetry axis A1 is a major axis of the micro lens 301, the symmetry axis A2 is a minor axis of the micro lens 301, and the major axis is, for example, 1.1 to 2 times the minor axis). An internal angle θ1 of the hexagon may fall within a range of 105° to 165°. That is, each of two internal angles θ2 located on the symmetry axis A1 may fall within a range of 30° to 150°. In other words, a virtual rectangle corresponding to the micro lens 301 has a long side W1 (corresponding to the symmetry axis A1) and a short side W2 (corresponding to the symmetry axis A2) of different sizes, as shown in FIG. 3B. In this embodiment, the spots generated by the light beams L11 and L12 irradiated on the micro-lens-array element 30 may be non-circular spots such as an ellipse. Compared to the use of the regular hexagonal micro lens 301 as shown in FIG. 2B, when the non-regular hexagonal micro lens 301 as shown in FIG. 3A is used for light homogenization, a shape of the spot on the light incident surface 41 of the light-homogenizing element 4 may be further adjusted, which is more suitable for the projection lens with the smaller aperture (diaphragm), so as to improve the efficiency of light use and obtain a more optimized homogenization result.

FIG. 3C is a schematic view of a micro lens of a micro-lens-array element according to another embodiment of the disclosure. Referring to FIGS. 1, 3A, and 3C together, in another embodiment of the disclosure, the light-homogenizing element 4 includes the lens-array, and an outline of each of micro lenses 301A of the light-homogenizing device 3 on the plane perpendicular to the optical axis of the light-homogenizing device 3 is a polygon (as shown in FIG. 3C, but is not limited to the octagon shown in FIG. 3C, and may be a decagon, a dodecagon, or a polygon with other numbers of sides, etc.). After multiple vertices of the polygon are connected, a virtual ellipse as shown in FIG. 3C is formed. That is, each of the vertices of the polygon falls on an outline of the virtual ellipse. In addition, a ratio of a major axis A3 to a minor axis A4 of the virtual ellipse is greater than 1 and less than 1.1. For a case where the spots formed by the light beams L11 and L12 irradiated on the light-homogenizing device 3 are elliptical spots or non-circular spots, the non-regular polygonal micro lens 301A as shown in FIG. 3C is used for the light homogenization, and the shape of the spot on the light incident surface 41 of the light-homogenizing element 4 may be further adjusted during the light homogenization, so that the spot is more symmetrical, and the illumination beam transmitted from the light-homogenizing element 4 may be suitable for the projection lens with the smaller aperture (diaphragm), so as to improve the efficiency of light use and obtain a more optimized image.

FIG. 3D is a schematic view of a micro lens of a micro-lens-array element according to still another embodiment of the disclosure. Compared to the embodiment shown in FIG. 3C, referring to FIGS. 1, 3A, and 3D together, in some embodiments, the light-homogenizing element 4 includes the lens-array. Each of micro lenses 301B of the light-homogenizing device 3 may be shown in FIG. 3D, and an outline of each of the micro lenses 301B on the plane perpendicular to the optical axis of the light-homogenizing device 3 is a regular polygon (as shown in FIG. 3D, but is not limited to the regular octagon shown in FIG. 3D, which may be a regular decagon, a regular dodecagon, or a regular polygon with other numbers of sides, etc.). Multiple vertices of the regular polygon form a virtual circle, and each of internal angles of the regular polygon is equal and greater than or equal to 120 degrees. For a case where the spots formed by the light beams L11 and L12 irradiated on the light-homogenizing device 3 are approximately circular spots, the regular polygonal micro lens 301B as shown in FIG. 3D is used for the light homogenization, and the spot on the light incident surface of the light-homogenizing element 4 may be maintained in an approximately circular shape, so that the illumination beam L0 transmitted through the light-homogenizing 4 may be suitable for the projection lens with the smaller aperture (diaphragm), so as to improve the efficiency of light use and obtain a more optimized image.

(A) of FIG. 3E is a schematic view of a spot at an aperture of a projection lens according to a comparative example, and (B) of FIG. 3E is a schematic view of a spot at an aperture of a projection lens according to an embodiment of the disclosure. Referring to FIG. 3E, the spot is homogenized by each of the micro lenses shown in FIGS. 3B, 3C, and 3D, and the shape of the spot is optimized. The spot at the aperture of the projection lens deposed behind the illumination system 100 (such as a virtual plane where the aperture is located) will have an approximately circularly symmetrical shape as shown in (B) of FIG. 3E, and fall within the aperture. Compared to the comparative example shown in (A) of FIG. 3E, a size of the spot at the aperture is different in different directions, and a portion of the spot falls outside the aperture. Therefore, the projection lens with the smaller aperture (diaphragm) may be used for the projection device in the embodiment of the disclosure, which greatly reduces the manufacturing difficulty and cost of the projection device.

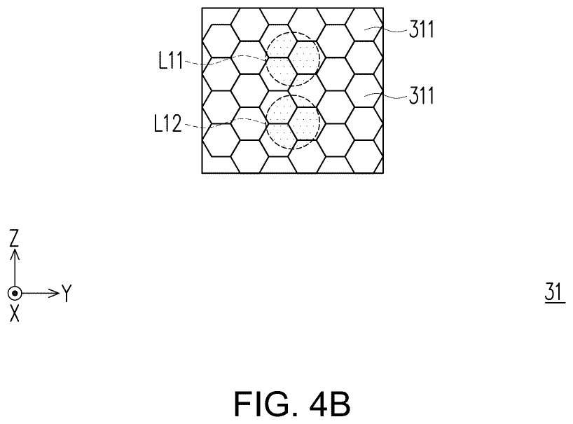

FIG. 4A is a schematic view of an illumination system according to the second embodiment of the disclosure. FIG. 4B is a front view of a micro-lens-array element according to the second embodiment of the disclosure. Referring to FIGS. 4A and 4B, an illumination system 200 is configured to provide the illumination beam L0. A difference between the illumination system 200 in FIG. 4A and the illumination system 100 in FIG. 1 is that the light-homogenizing device 3 includes a micro-lens-array element 31 and a lens 32. The lens 32 is disposed between the micro-lens-array element 31 and the light-homogenizing element 4. The micro-lens-array element 31 includes multiple micro lenses 311, and the micro lenses 311 have the same thickness in a direction parallel to the optical axis (for example, lens surface vertices on the same side of each of the micro lenses 311 fall on the same plane). Specifically, each of the micro lenses 311 has a diopter, and the lens 32 has a positive diopter, so that the diopter of the light-homogenizing device 3 is further changed by the lens 32. That is, the diopter of the light-homogenizing device 3 is implemented by the lens 32. In some embodiments, the lens 32 may be implemented with multiple lenses.

In this embodiment, the light beams L11 and L12 are parallel to each other before being incident on the micro-lens-array element 31, and after passing through the micro-lens-array element 31, the light beams L11 and L12 are refracted at a small angle and then diverge into the lens 32. The light beams L11 and L12 in this embodiment are both homogenized by at least two of the micro lenses 311 irradiated by the light beams L11 and L12, and converged on the light incident surface 41 of the light-homogenizing element 4 after passing through the lens 32 with the diopter and generate the hexagonal homogenized spot L1 on the light incident surface 41 of the light-homogenizing element 4 as shown in FIG. 2C. It should be noted that although in this embodiment, the regular hexagon as shown in FIG. 4B is used to illustrate the micro lens 311, the disclosure is not limited thereto. In some embodiments, the micro lens 311 may have a non-regular polygonal outline as shown in FIGS. 3B and 3C, a regular polygonal outline as shown in FIG. 3D, or a rectangular outline as described in FIG. 8B below.

According to an embodiment of the disclosure, the micro-lens-array element 31 (or the micro-lens-array element 30) is configured to vibrate in a direction perpendicular to the optical axis of the micro-lens-array element, so that the spot generated on the light incident surface of the light-homogenizing element 4 may be further homogenized.

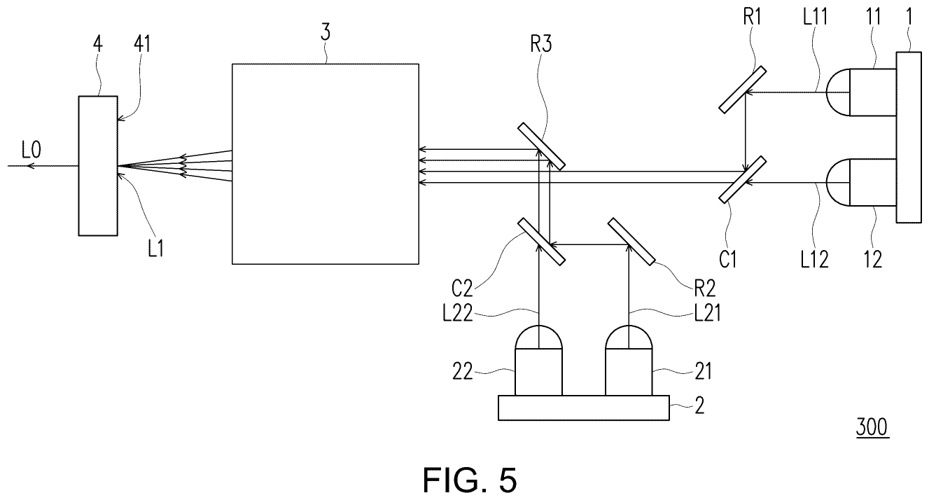

FIG. 5 is a schematic view of an illumination system according to the third embodiment of the disclosure. Referring to FIG. 5, an illumination system 300 is configured to provide the illumination beam L0, and includes the light source 1, a light source 2, reflectors R1, R2, and R3, light-combining elements C1 and C2, the light-homogenizing device 3, and the light-homogenizing element 4.

The light source 1 may be a color light source module, and includes the light-emitting units 11 and 12, which respectively emit the light beams L11 and L12 of different colors. The light source 2 may be a color light source module, and includes light-emitting units 21 and 22, which respectively emit lights beams L21 and L22 of different colors. A color of the light beam L21 may optionally be the same as a color of the light beam L11 or L12, but the disclosure is not limited thereto. The light-combining elements C1 and C2 may be dichroic mirrors. Specifically, the light beam L11 is reflected by the reflector R1, then reflected by the light-combining element C1, and then transmitted to the light-homogenizing device 3. The light beam L12 passes through the light-combining element C1 and then is transmitted to the light-homogenizing device 3. The light beam L21 is reflected by the reflector R2, reflected by the light-combining element C2, then reflected by the reflector R3, and then transmitted to the light-homogenizing device 3. The light beam L22 passes through the light-combining element C2, then is reflected by the reflector R3, and then transmitted to the light-homogenizing device 3. The non-overlapping or partially overlapping light beams L11, L12, L21, and L22 may converge on the light incident surface 41 of the light-homogenizing element 4 after passing through the light-homogenizing device 3 to form the hexagonal homogenized spot L1 as shown in FIG. 2C. That is to say, for the illumination system 300 provides with the light sources 1 and 2, the reflectors R1, R2, and R3 for light combining, and the light-combining elements C1 and C2, the light beams L11, L12, L21, and L22 may be transmitted in a non-overlapping or partially overlapping manner by disposing the light-homogenizing device 3 without restricting the light beams L11, L12, L21, and L22 to be incident on the light-homogenizing element 4 in a totally overlapping manner as in the comparative example without disposing the light-homogenizing device 3, which greatly increases a configuration margin of each of the elements in the illumination system 300.

In some embodiments, the light beams L11, L12, L21, and L22 are totally overlapped before being incident on the light-homogenizing device 3, and may also be converged on the light incident surface of the light-homogenizing element 4 through the light-homogenizing device 3 to generate the hexagonal homogenized spot L1 as shown in FIG. 2C.

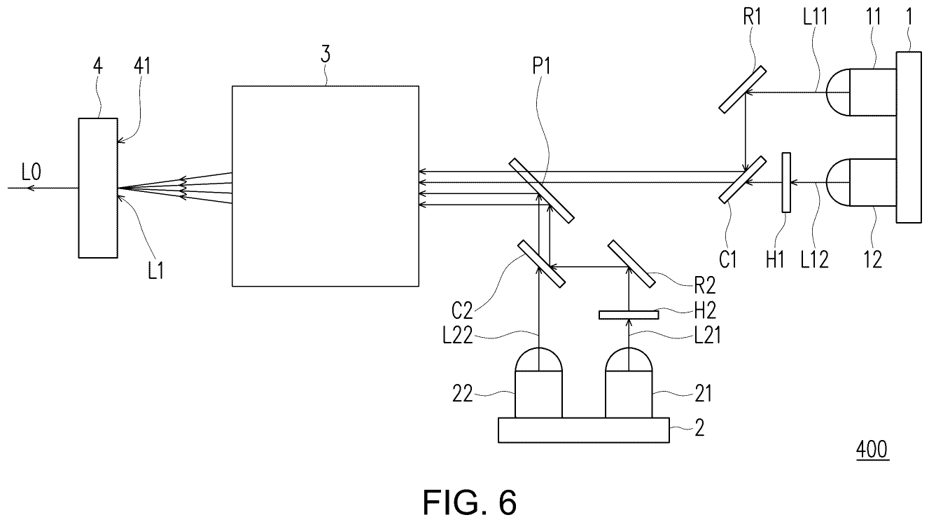

FIG. 6 is a schematic view of an illumination system according to the fourth embodiment of the disclosure. Referring to FIG. 6, an illumination system 400 is configured to provide the illumination beam L0, and includes the light source 1, the light source 2, the reflectors R1 and R2, the light-combining elements C1 and C2, half-wave plates H1 and H2, a polarization beam splitter P1, the light-homogenizing device 3, and the light-homogenizing element 4.

The light source 1 may be the color light source module, and includes the light-emitting units 11 and 12, which respectively emit the light beams L11 and L12 of different colors. The light source 2 may be the color light source module, and includes the light-emitting units 21 and 22, which respectively emit the light beams L21 and L22 of different colors. The light-combining elements C1 and C2 may be the dichroic mirrors. Specifically, the light beam L11 is sequentially reflected by the reflector R1 and the light-combining element C1 to form p light, and passes through the polarization beam splitter P1 and then is transmitted to the light-homogenizing device 3. The light beam L12 sequentially passes through the half-wave plate H1 and the light-combining element C1 to form the p light, and passes through the polarization beam splitter P1 and then is transmitted to the light-homogenizing device 3. After passing through the half-wave plate H2, the light beam L21 is sequentially reflected by the reflector R2 and the light-combining element C2 to form s light, and reflected by the polarization beam splitter P1 and then transmitted to the light-homogenizing device 3. The light beam L22 passes through the light-combining element C2 and forms the s light, and is reflected by the polarization beam splitter P1 and then transmitted to the light-homogenizing device 3. The non-overlapping or partially overlapping light beams L11, L12, L21, and L22 may be converged on the light incident surface 41 of the light-homogenizing element 4 after passing through the light-homogenizing device 3 to form the hexagonal homogenized spot L1 as shown in FIG. 2C. That is to say, for the illumination system 400 provided with the light sources 1 and 2, the reflectors R1 and R2 for light combining, the light combining elements C1 and C2, the half-wave plates H1 and H2, and the polarization beam splitter P1, the light beams L11, L12, L21, and L22 may be transmitted in a non-overlapping or partially overlapping manner by disposing the light-homogenizing device 3 without restricting the light beams L11, L12, L21, and L22 to be incident on the light-homogenizing element 4 in a totally overlapping manner as in the comparative example without disposing the light-homogenizing device 3, which greatly increases a configuration margin of each of the elements in the illumination system 400. In particular, in other embodiments, the light-emitting units 11 and 12 may respectively emit the light beams L11 and L12 of the same color, and the light-emitting units 21 and 22 may respectively emit the light beams L21 and L22 of the same color. The light beam L11 and the light beam L21 may optionally be the same or different colors, and the light-combining elements C1 and C2 may be polarization beam splitters.

In some embodiments, the light beams L11, L12, L21, and L22 are totally overlapped before being incident on the light-homogenizing device 3, and may also be converged on the light incident surface of the light-homogenizing element 4 through the light-homogenizing device 3 to generate the hexagonal homogenized spot L1 as shown in FIG. 2C.

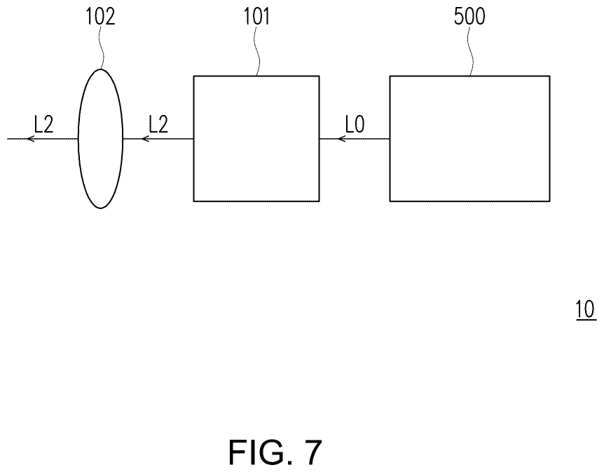

FIG. 7 is a schematic view of a projection device according to an embodiment of the disclosure. Referring to FIG. 7, a projection device 10 includes an illumination system 500, an optical engine module 101, and a projection lens 102. The illumination system 500 is configured to provide the illumination beam L0, which may be implemented by any one of the illumination systems 100, 200, 300, and 400. The optical engine module 101 is disposed on a transmission path of the illumination beam L0 to convert the illumination beam L0 into an image beam L2. The optical engine module 101 may include an image generating device such as a light valve, a digital micromirror device, or a liquid crystal panel. The projection lens 102 is disposed on a transmission path of the image beam L2 to project the image beam L2 out of the projection device 10, and the projection lens 102 has one or more lenses or lens sets, for example. Since the illumination systems 100, 200, 300, and 400 are provided with the light-homogenizing device 3, the projection device 10 may adopt the projection lens 102 with the smaller aperture (diaphragm), which greatly reduces the manufacturing difficulty and cost.

Next, referring to FIGS. 1, 7, and 8A to 8E together, FIGS. 8A to 8E are respectively a schematic view of a light incident surface of a light-homogenizing element, a front view of a micro-lens-array element, a schematic view of a spot irradiated on a micro-lens-array element, a schematic view of an image generating device, and a schematic view of a spot at an aperture of a projection lens according to the fifth embodiment of the disclosure. In the fifth embodiment of the disclosure, the projection device 10 also includes the illumination system 500, the optical engine module 101, and the projection lens 102. The illumination system 500 also includes the light source 1, the light-homogenizing device 3, and the light-homogenizing element 4 (marked as shown in FIG. 1). The light-homogenizing element 4 is the integration rod as shown in FIG. 8A. A light incident surface of the integration rod is a rectangle, and the rectangle has a length Ry and a width Rz in a Y direction and a Z direction respectively, where Ry/Rz=K. In some embodiments, K may be an arbitrary constant, and K is, for example, greater than or equal to 0.3 and less than or equal to 3.

The light-homogenizing device 3 in the illumination system 500 includes a micro-lens-array element 33 as shown in FIG. 8B. The micro-lens-array element 33 includes multiple micro lenses 331. An orthogonal projection outline of each of the micro lenses 331 on the plane perpendicular to the optical axis of the light-homogenizing device (such as a YZ plane, as shown in FIG. 8B) is a rectangle, and each of the orthogonal projection outlines (rectangle) has a length Cy and a width Cz in the Y direction and the Z direction respectively. In particular, the micro-lens-array element 33 may be similar to the micro-lens-array element 30 shown in FIG. 2A, in which a light incident surface and a light exit surface of the micro-lens-array element 33 are both curved surfaces, or may be similar to the micro-lens-array element 31 shown in FIG. 4A, in which the light incident surface and the light exit surface of the micro-lens-array element 33 are both approximately flat surfaces, and one or more lenses are used to implement the diopter of the light-homogenizing device.

When multiple light beams Lij emitted by the light source 1 in the illumination system 500 irradiate the micro-lens-array element 33, a spot SP jointly formed by the light beams Lij on the light incident surface of the micro-lens-array element 33 has a rectangular outline (For example, multiple spot points arranged in a matrix to jointly form the spot SP. A range of the spot points is defined by a full width at half maximum of each of the spot points, and the rectangular outline of the spot SP is, for example, a tangent connection between the ranges of the surrounding spots, as shown in FIG. 8C. If the tangent connections on the same side are not collinear, the tangent connections farthest from a center of the spot SP is selected as one side of the rectangular outline, but the range of the rectangular outline in the disclosure is not limited to the above). The rectangular outline has a length Sy and a width Sz in the Y direction and Z direction respectively, where Sy/Sz=S, as shown in FIGS. 8B and 8C. In addition, when the light beams Lij pass through the micro-lens-array element 33 and are homogenized by the micro-lens-array element 33, the homogenized spot L1 will be formed on the light incident surface 41 of the light-homogenizing element 4, and the spot L1 will be approximately rectangular in shape, as shown in FIG. 8A.

In this embodiment, the optical engine module 101 includes an image generating device 101A as shown in FIG. 8D. An optical surface of the image generating device 101A has a length Py and a width Pz, and the illumination beam L0 is incident on the image generating device 101A with an azimuthal angle θ and a direction angle v. The azimuthal angle θ refers to an orthographic projection of the illumination beam L0 (a main beam) on a virtual plane where the optical surface of the image generating device 101A is located, which is an included angle between the orthographic projection of the illumination beam L0 and a horizontal line (for example, a direction parallel to the length Py). The direction angle ψ refers to the orthographic projection of the illumination beam L0 on the virtual plane perpendicular to the optical surface and parallel to a vertical line (for example, a direction parallel to the length Pz), which is an included angle between the orthographic projection of the illumination beam L0 and a normal direction of the optical surface.

It should be particularly noted that by calculating a size of the image generating device 101A, the azimuthal angle θ, the direction angle ψ, and a geometric relationship of the aperture of the projection lens 102, it may be found that when the length Sy and the width Sz of the spot SP on the micro-lens-array element 33, the length Ry and the width Rz of the light incident surface of the integration rod, and the length Cy and the width Cz of each of the micro lenses 331 satisfy conditional formulas Ry/Rz=K, Sy/Sz=S, Cy/Cz=K×S, and 0.8<K×S<3 at the same time, there will have a better display effect, where K×S may further correspond to an angle of the illumination beam L0 incident on the image generating device 101A.

$$K \times S = \frac{S y \times P y \times cos ( {sin}^{- 1} ( sin ψ \times cos θ ) )}{S z \times P z \times cos ( {sin}^{- 1} ( sin ψ \times sin θ ) )}$$

Specifically, by satisfying the conditional formulas, the spot at the aperture of the projection lens 102 will be formed inside the aperture as shown in (B) of FIG. 8E. Compared to a case in which a portion of the spot falls outside the aperture in the comparative example shown in (A) of FIG. 8E, the projection lens 102 with the smaller aperture (diaphragm) may be adopted for the projection device 10 in this embodiment, which greatly reduces the manufacturing difficulty and cost of the projection device 10.

Based on the above, in the illumination system provided in the embodiment of the disclosure, the light-homogenizing device is used to homogenize and refract the overlapping, non-overlapping or partially overlapping light beams to generate the illumination beam with high uniformity and small beam width. The projection lens with the smaller aperture may be adopted for the projection device using the illumination system, which greatly reduces the manufacturing difficulty and cost, and may provide the optimized image beam.

The above content demonstrates exemplary embodiments of the invention, and the scope of the implementation of the invention cannot be limited thereto. That is, all equivalent changes and modifications made in accordance with the claims and specification of the invention still fall within the scope covered in the patent of the invention. In addition, any of the embodiments or claims of the invention does not have to achieve all the objectives or advantages or features disclosed in the invention. In addition, the abstract and title are merely used to facilitate the search of patent documents, and do not limit the scope of the invention. In addition, the terms “first” and “second” mentioned in the specification or claims are only used to name the elements or to distinguish between different embodiments or ranges, and are not used to limit the upper or lower limit of the number of elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, configured to provide an illumination beam, comprising:
a light source, comprising a plurality of light-emitting units, wherein the light-emitting units respectively emit a plurality of light beams;
a light-homogenizing device, comprising a micro-lens-array element, wherein the micro-lens-array element comprises a plurality of micro lenses, the light beams irradiate the micro-lens-array element, and each of the light beams irradiates at least two of the micro lenses; and
a light-homogenizing element, wherein the light beams are non-overlapped or at least partially overlapped with each other before being incident on the light-homogenizing device, and the light beams are overlapped on a light incident surface of the light-homogenizing element.

2. The illumination system according to claim 1, wherein the micro-lens-array element has a positive diopter.

3. The illumination system according to claim 1, wherein the light-homogenizing device further comprises at least one lens disposed between the micro-lens-array element and the light-homogenizing element, and the at least one lens has a positive diopter.

4. The illumination system according to claim 3, wherein the micro lenses have a same thickness in a direction parallel to an optical axis of the light-homogenizing device.

5. The illumination system according to claim 4, wherein the micro-lens-array element is configured to vibrate in a direction perpendicular to the optical axis.

6. The illumination system according to claim 1, further comprising a reflector and a light-combining element disposed between the light source and the light-homogenizing device, wherein the reflector and the light-combining device are configured to enable the light beams to be incident on the light-homogenizing device at a same angle.

7. The illumination system according to claim 6, wherein the light beams have different light frequency ranges, and the light-combining element is a dichroic mirror.

8. The illumination system according to claim 1, further comprising a reflector, wherein the light-emitting units comprise a plurality of first light-emitting units and a plurality of second light-emitting units, and the light beams comprise a plurality of first light beams emitted by the first light-emitting units and a plurality of second light beams emitted by the second light-emitting units, wherein the second light beams are reflected by the reflector and then incident on the light-homogenizing device.

9. The illumination system according to claim 1, further comprising a polarization beam splitter, wherein the light-emitting units comprise a plurality of first light-emitting units and a plurality of second light-emitting units, the light beams comprise a plurality of first light beams emitted by the first light-emitting units and a plurality of second light beams emitted by the second light-emitting units, the first light beams are incident on the light-homogenizing device after passing through the polarization beam splitter, and the second light beams are reflected by the polarization beam splitter and then incident on the light-homogenizing device.

10. The illumination system according to claim 9, further comprising a first reflector, a first half-wave plate, and a first light-combining element disposed between the first light-emitting units and the polarization beam splitter, and a second reflector, a second half-wave plate, and a second light-combining element disposed between the second light-emitting units and the polarization beam splitter.

11. The illumination system according to claim 1, wherein the light-homogenizing element comprises an integration rod, a light incident surface of the integration rod is rectangular, and an orthogonal projection outline of each of the micro lenses of the light-homogenizing device on a plane perpendicular to an optical axis of the light-homogenizing device is rectangular.

12. The illumination system according to claim 11, wherein the light incident surface of the integration rod has a length Ry and a width Rz in a first direction and a second direction respectively, Ry/Rz=K, where K is an arbitrary constant, the light beams irradiate the micro-lens-array element and form a spot on a light incident surface of the micro-lens-array element, the spot has a length Sy and a width Sz in the first direction and the second direction respectively, Sy/Sz=S, and the illumination system satisfies a conditional formula 0.8<K×S<3.

13. The illumination system according to claim 12, wherein the orthogonal projection outline of each of the micro lenses has a length Cy and a width Cz in the first direction and the second direction respectively, and Cy/Cz=K×S.

14. The illumination system according to claim 1, wherein the light-homogenizing element comprises an lens-array, an outline of each of the micro lenses of the light-homogenizing device on a plane perpendicular to an optical axis of the light-homogenizing device is a regular polygon, and each of internal angles of the regular polygon is greater than or equal to 120 degrees.

15. The illumination system according to claim 1, wherein the light-homogenizing element comprises an lens-array, an outline of each of the micro lenses of the light-homogenizing device on a plane perpendicular to an optical axis of the light-homogenizing device is a polygon, a plurality of vertices of the polygon form a virtual ellipse, and a ratio of a major axis to a minor axis of the virtual ellipse is greater than 1 and less than 1.1.

16. A projection device, comprising:
an illumination system, configured to provide an illumination beam, comprising:
a light source, comprising a plurality of light-emitting units, wherein the light-emitting units respectively emit a plurality of light beams;
a light-homogenizing device, comprising a micro-lens-array element, wherein the micro-lens-array element comprises a plurality of micro lenses, the light beams irradiate the micro-lens-array element, and each of the light beams irradiates at least two of the micro lenses; and
a light-homogenizing element, wherein the light beams are non-overlapped or at least partially overlapped with each other before being incident on the light-homogenizing device, and the light beams are overlapped on a light incident surface of the light-homogenizing element;
an optical engine module, disposed on a transmission path of the illumination beam to convert the illumination beam into an image beam; and
a projection lens, disposed on a transmission path of the image beam to project the image beam out of the projection device.
